(19) United States
(12) Patent Application Publication
(10) Pub. No.: US 2004/0047669 A1
(43) Pub. Date: Mar. 11, 2004

(54) Side knock or end knock mechanical pencil for thick lead

(76) Inventor: David Lo, Alhambra, CA (US)

Correspondence Address: David T. Bracken, The Law Office of David T. Bracken, 4839 Bond Avenue, Orange, CA, 92869, US

(21) Appl. No.: 10/236,497

(22) Filed: Sep. 6, 2002

(51) Int. Cl. B43K 21/22

(52) U.S. Cl. 401/92; 401/88

(57) ABSTRACT

The present invention is a mechanical pencil adapted to securely hold and advance square or rectangular leads. The invention mechanism is a single opened end slotted front guide for the lead where compression and decompression of the lead is accomplished by causing thickened arms of the front guide to be drawn into and pushed out of an opening of another piece aligning the front guide with the axis of a pencil housing.

### BACKGROUND OF THE INVENTION

The present invention relates to mechanical pencils.

A side knock type mechanical pencil including a cylindrical shell having a ferrule is shown in U.S. Pat. No. 6,099,182

U.S. Pat. No. 1,916,199 shows a square lead fixed in a holder that is not adjustable. U.S. Pat. No. 3,537,799 shows a mechanism for advancing a square lead with side sliding device. similar to yours but not for a side knock configuration), U.S. Pat. No. 6,099,182 (showing a well known side knock mechanism except with radial pinching for the small diameter lead). U.S. Pat. Nos. 2,274,311 and 4,505,606 show the use of an end knock or twist mechanism to push a square or rectangular lead out of a housing.

### SUMMARY OF THE INVENTION

The present invention is a mechanical pencil with a side or end knock. An internal mechanism grasps a square or rectangular lead at a side location, holds it securely there so that lead extending beyond the pencil opening can be used, and permits the lead to be advanced in small increments without releasing the secure hold on the lead.

The types of lead that will be used in the invention device are well known in the art of construction. One of such leads is a rectangular cross section lead. Another is a square cross section lead. In a preferred example below, a lead with a cross section of about 5-6 millimeters by about 2-3 millimeters is used.

### BRIEF DESCRIPTION OF THE DRAWINGS

FIGS. 1 and 2 are exploded and assembled perspective views of the invention pencil.

FIGS. 3-7 are respectively perspective external, flat and longitudinal side cutaway, narrow and longitudinal side cutaway, bottom end and cross section cutaway at the button opening views of the pencil housing.

FIGS. 8-10 are respectively perspective, front and bottom views of the pencil cap.

FIGS. 11-15 are respectively perspective, left side, front side, right side and bottom views of the invention back bush that secures the back of the pencil lead case within the housing.

FIGS. 16-21 are respectively perspective, front, right side, broad part cross section cutaway, top end, and narrow part cross section cutaway of the pencil lead case.

FIGS. 22-26 are respectively bottom perspective, top perspective, left, longitudinal side cutaway, and bottom views of the side knock button part of the pencil.

FIGS. 27-30 are respectively perspective, longitudinal side cutaway, top end and bottom end views of the pencil's body bush adapted to connect the pencil lead case with the front guide.

FIGS. 31-38 are respectively perspective, front, front side cutaway, left or right side, left or right side cutaway, bottom end, top end, and mid part cross section cutaway views of the front guide that secures and advances the pencil lead.

FIGS. 39-42 are respectively perspective, front, left or right side cutaway, front side cutaway, and bottom views of the front bush that secures and guides the pencil lead to the pencil's end opening for the lead.

FIGS. 44-46 are respectively perspective, side cutaway and bottom views of the cube ring that engages the top end of the front guide.

FIG. 47 shows the invention mechanism in a side cutaway view with the side knock button un-depressed.

FIG. 48 shows the invention mechanism in a side cutaway view with the side knock button depressed, urging the lead forward.

FIG. 49 is an exploded view of an invention embodiment similar to that of FIG. 1.

FIG. 50 is an side and cross section view of an invention embodiment similar to that of FIG. 48 with the button in the uncompressed position.

FIGS. 51-55 are respectively bottom side, side perspective, top end and top side views of piece 211a of the invention embodiment of FIG. 49 and operating directly and integrally with a button contact piece shown in FIG. 49, the two pieces forming the button.

FIGS. 56-60 are respectively side perspective, side, short side cross section, long side cross section, and end views of a body bush of an invention embodiment similar to the one in FIGS. 40-43.

FIGS. 61-67 are respectively side perspective, short side, long side, short side cross section, long side cross section, bottom end and top end views of a front guide of an invention embodiment similar to the one in FIGS. 40-43.

### DETAILED DESCRIPTION OF THE INVENTION

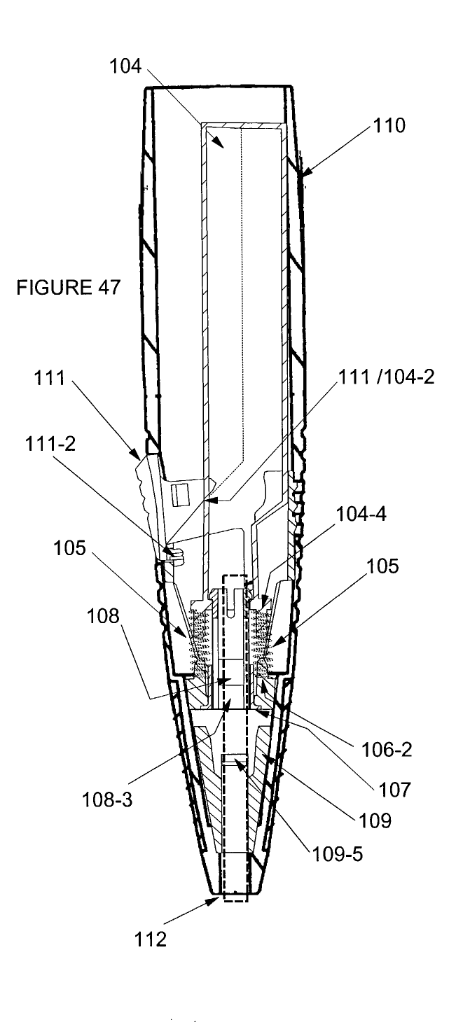

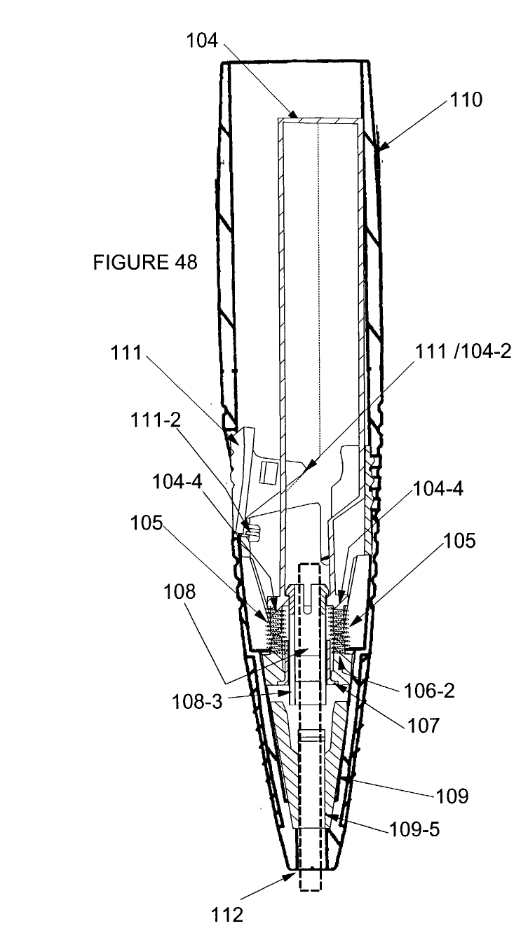

The invention is now discussed with reference to the figures. The orientations of the invention described below are as if the mechanical pencil were vertical with the writing end at the bottom and the flat side of the pencil housing were facing the viewer, as in FIGS. 47 and 48.

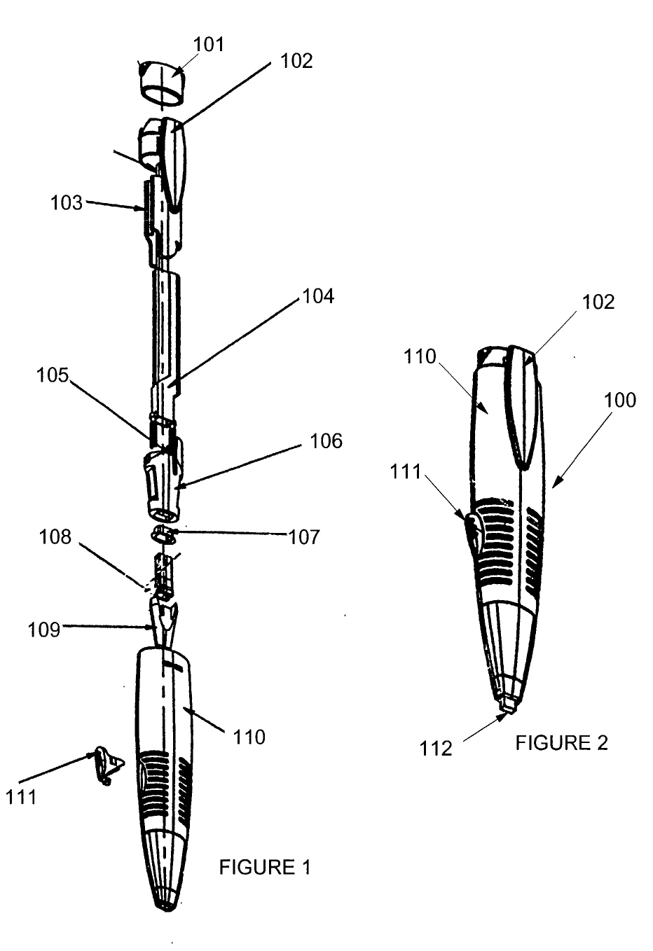

FIG. 1 shows the invention pencil 100 with its parts exploded and in FIG. 2 as an assembled pencil with a rectangular lead 112 visible at its bottom end. FIG. 1 shows that cap end pieces 101 and 102 combine to cover the top end of the pencil by fitting snugly over the top end of the housing 110. Encased in the housing 110 and capped with pieces 101 and 102 is the invention mechanism. Back bush 103 is adapted to secure the top end of lead case 104 against the pieces 101 and 102 so that lead case 104 is urged against the spring force of springs 105 that connect the bottom end of lead case 104 and securing lugs on body bush 106. Front guide 108 holds and moves a lead 112 forward by being operated upon by body bush 106 holding a cube ring 107, which ring 107 is secured in body bush 106 so that it can allow the front guide 108 to slide forward and back with respect to body bush 106 to compress and decompress a rectangular lead 112 on its long sides and advance the lead 112 upon depression of the lead advancing button 111. Pinching arms of the front bush 109 generally hold and guide the lead 112 toward the opening in the housing 110 for the lead 112.

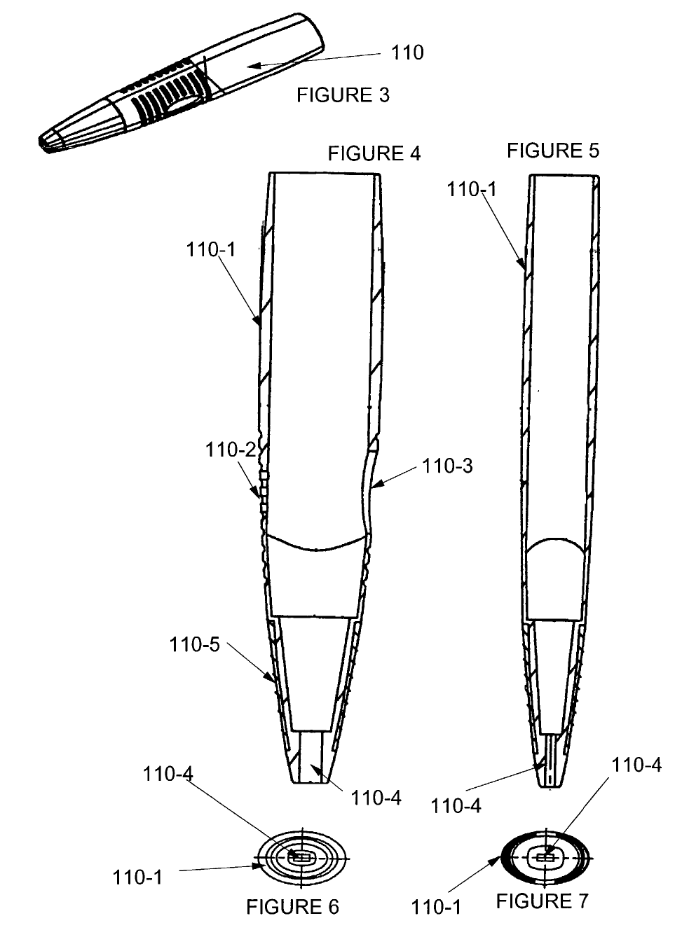

FIGS. 3-7 are respectively perspective external, flat and longitudinal side cutaway, narrow and longitudinal side cutaway, bottom end and cross section cutaway at the button opening views of the pencil housing 110, wherein an upper housing 110-1 is a flattened and rigid structure with an approximate oval cross section comprising body bush securing holes 110-2 for receiving projections from body bush 106 and button hole 110-3 for receiving in operational rotation the top of button 111. The lower housing 110-5 comprises internal bores for the receiving and abutting securing outer surfaces of front bush 109 and forward outer surfaces of body bush 106. Opening 110-4 is the opening for guiding and supporting lead 112 through the housing to make it available for use by the user. Another opening at the side of body bush 106 is adapted to receive a projection from button 111 so that button 111 rotates about that connection during operation of the pencil in advancing the lead 112.

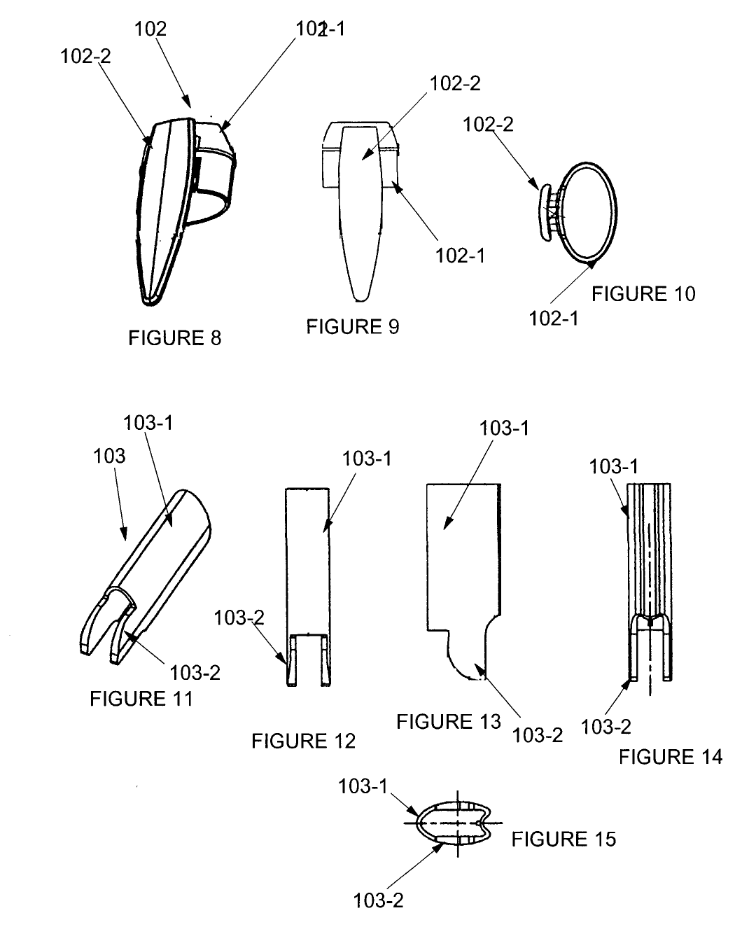

FIGS. 8-10 are respectively perspective, front and bottom views of the pencil cap 102, wherein an oval and hollow body part 102-1 is adapted to be inserted into the top opening of housing 110. Part 102-1 has extending from it extension 102-2 for securing the invention pencil in a pocket or on a belt.

FIGS. 11-15 are respectively perspective, left side, front side, right side and bottom views of the invention back bush 103 that secures the back of the pencil lead case 102 within the housing 110. A back part 103-1 is adapted to secure within its capped U-shaped bore a top portion of the lead case 104 so that it is secured in a parallel relationship the axis of housing 110 for forward and back movement. The outer surface of back part 103-1 is adapted to rest securely against the inside of the housing 110 in the upper housing 110-1. A top to middle part of lead case 104 is adapted to be slidingly secured in the bore of back part 103-1. Forward arms 103-2 are adapted to engage the narrowed longitudinal outer surface of lead case 104.

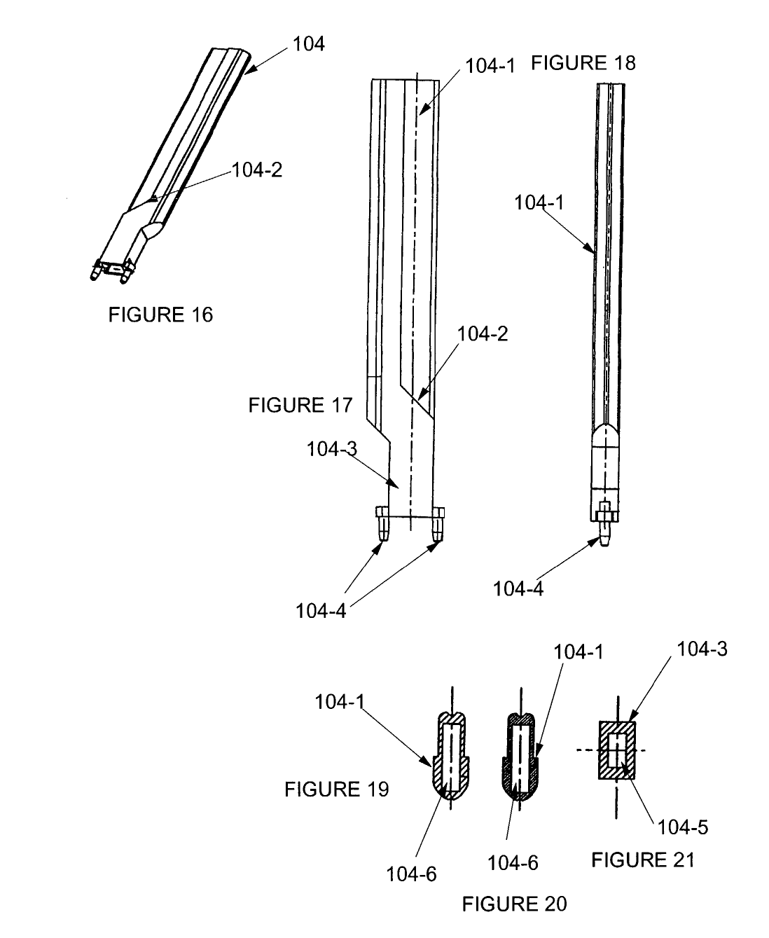

FIGS. 16-21 are respectively perspective, front, right side, broad part cross section cutaway, top end, and narrow part cross section cutaway of the pencil lead case 104, which comprises a back guide for lead 112, wherein a top body 104-1 has a cross section as seen in FIG. 19 and 20 with a bore 104-6 for holding multiple rectangular leads 112, one of which is operatively passed to bore 104-5 as in FIG. 21, cross section of front end 104-3. Front end 104-3 comprises lug 104-4 for securing ends of springs 105, so that forward motion of the lead case 104 causes compression of the springs 105 against the securing lugs of body bush 106. The broken line axis shown in FIGS. 17 and 18 is the broken line axis shown in other figures, but which represents the axis of rectangular lead 112 in operational engagement with the lead case 104, body bush 106, cube ring 107, front guide 108, front bush 108 and the opening of housing 110 for extrusion of lead 112. Lead case 104 is adapted to have advancement ledges 104-2 on both sides of the case 104 to be abutted and engaged with button 111's legs as they rotate in a forward motion that causes lead case 104 to move forward against the spring pressure of springs 105. Opening 104-5 is adapted to receive the top end of front guide 108 so that its notches at that end snap fit into that end of the lead case 104, where those notches are caused to just pass through the opening 104-5 to the greater diameter area above it.

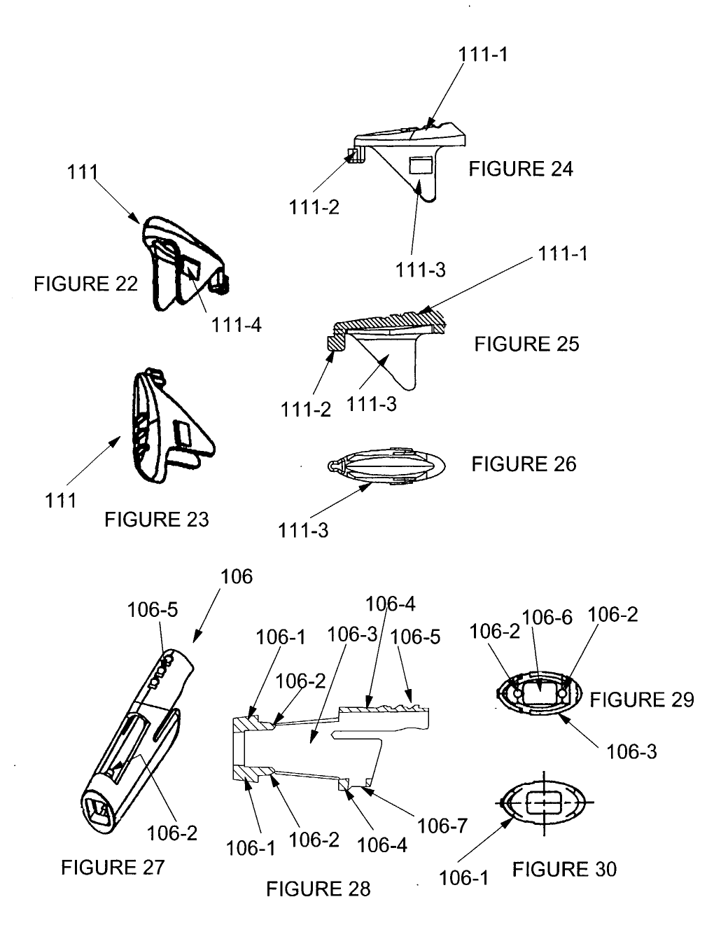

FIGS. 22-26 are respectively bottom perspective, top perspective, left, longitudinal side cutaway, and bottom views of the side knock button 111, wherein a top surface 111-1 is where the user presses with finger pressure to cause advancement of lead 112. Legs 111-3 extend from the top surface 111-1 to engage ledges 104-2 (FIGS. 16 and 17) at angled edges. It is within the invention to make the ledges 104-2 substantially normal to the axis of lead 112 and the engaging edges of the legs 111-3 appropriately. Front lug 111-3 engages the above mentioned opening in the body bush 106 after lug 111-3 is passed through opening 110-3 (FIG. 4) to secure button 111 rotatingly at the lug with respect to the housing 110. Extensions 111-4 extend from the outside surfaces of legs 111-3 further retaining button 111 in opening 110-3.

FIGS. 27-30 are respectively perspective, longitudinal side cutaway, top end and bottom end views of the pencil's body bush 106 adapted to operatively connect the pencil lead case 104 motion to motion of the front guide 108. Generally, body bush 106 abuts an outside surface of front part 106-1 against the inside front part 110-5 of housing 110, and is further secured in housing 110 by notches 106-5 on extension 106-4 by snap fitting into holes 110-2 of housing 110 and causing button lug engaging extension 106-4 to abut the inside of the housing 110 opposite from holes 110-2. Body bush 106 is secured very firmly in housing 110 in the assembled pencil. Spring engaging lugs 106-2 secure the ends of springs 105 that are opposite the lugs 104-4 on lead case 104 in the assembled pencil. Opening 106-6 receives cube ring 107 so that front guide 108 will be secured within it as described below.

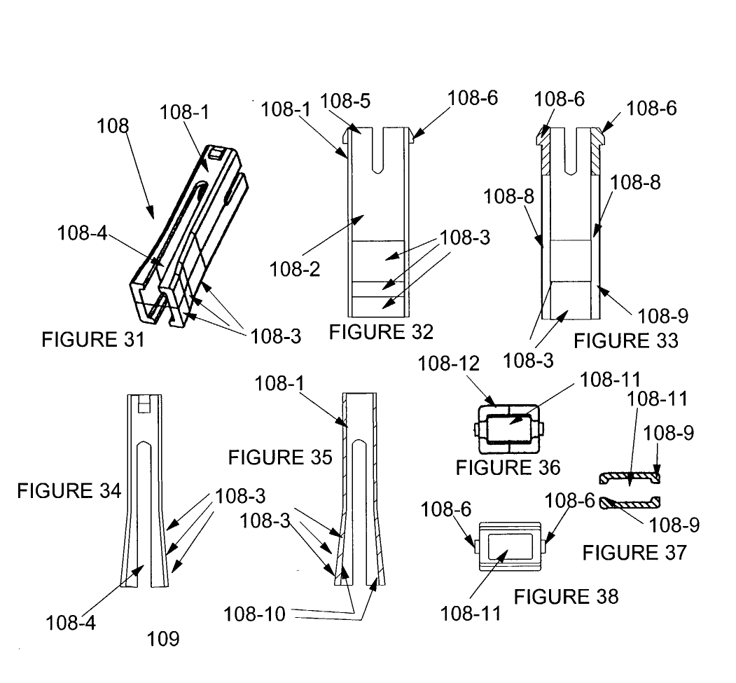

FIGS. 31-38 are respectively perspective, front, front side cutaway, left or right side, left or right side cutaway, bottom end, top end, and mid part cross section cutaway views of the front guide 108 that secures and advances the pencil lead 112. Front guide 108 is performs all the compression and decompression motion on the lead in the invention pencil. A top end 108-1 has an opening 108-5 for lead 112 to pass through without substantial compression. That opening extends to passage 108-11 and ending at an opening 108-12 at the bottom end of front guide 108. Passage 108-11 comprises slots 108-4, forming arms 108-2 that have increasing wedge compression sections 108-3. Sections 108-3 are adapted to be compressed so that surfaces 108-10 press onto the long sides of lead 112 by the inside of cube ring 107 when sections 108-3 drawn into cube ring 107 and to expand away from the lead 112 when arms 108-2 are pushed out from it, as further described below. The at-rest position of front guide 108 is such that the sections 108-3 are compressed substantially completely within cube ring 104, which is lodged in the opening 106-6 of body bush 106. When front guide 108 is forced downward by action of depressing button 111, cube ring 107 stays lodged in opening 106-6 and arms 108-2 emerge downward and expand away from lead 112 so that the lead is advanced. When button 111 is released from the depressed state, arms 108-2 retract into cube ring 107, thereby re-establishing secure compression on the lead sufficient for writing with the pencil by a user. Retaining rims 108-8 are formed around at edges 108-9 of slot 108-4 so that the lead 112 will be guided toward the front bush 109. Front guide 108 is preferably formed from an elastomer or other compressible material with substantial coefficient of friction to accomplish the objects of the invention.

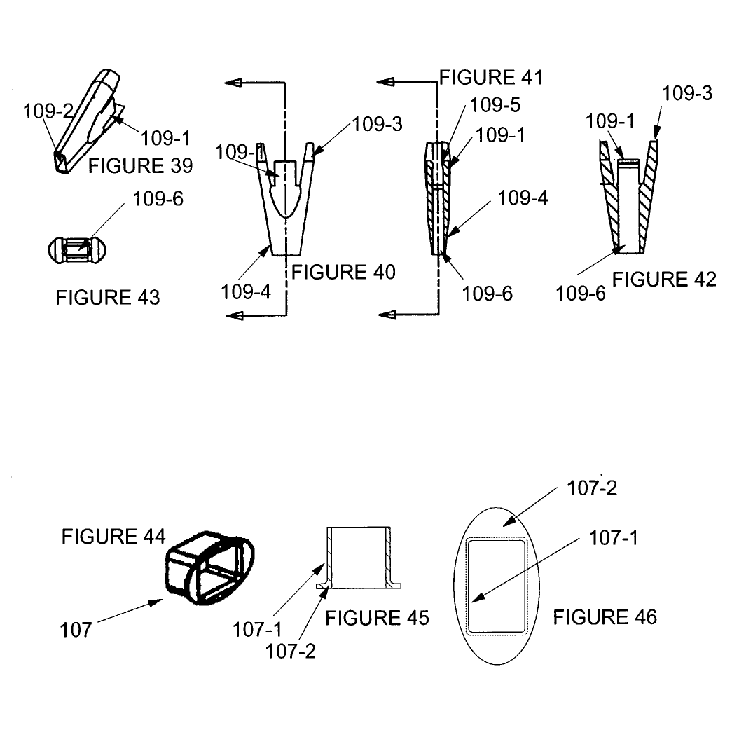

FIGS. 39-42 are respectively perspective, front, left or right side cutaway, front side cutaway, and bottom views of the front bush 109 that secures and guides the pencil lead 112 to the pencil's end opening for the lead. The lead 112 emerging from the bottom end 108-12 of front guide 108 is moved toward the slotted opening in arms 109-1 that comprises narrowed neck 109-5, which expands downward to passage 109-6. Passage 109-6 is adapted to permit the lead 112 to move substantially without resistance and provides guidance and support for lead 112 as it moves from the bottom end of front guide 108 to the opening of the housing 110 for the lead 112. Legs 109-3 are formed so that front bush rests securing inside the lower most cavity of housing 110 and so that opening 109-2 of passage 109-6 in lower section 109-4 is aligned with the housing 110 opening for lead 112.

FIGS. 44-46 are respectively perspective, side cutaway and bottom views of the cube ring 107 that engages the sections 108-3 of arms 108-2 of the front guide 108. Cylindrical or oval part 107-1 extends up from a stay rim 107-2. Part 107-1 is located securely in opening 106-6 so that rim 107-2 abuts the bottom end of body bush 106 around that opening 106-6. During all operations of the invention pencil, cube ring 107 remains in position within opening 106-6.

FIG. 47 shows the invention mechanism in a side cutaway view with the side knock button 111 un-depressed and the pencil in a mode so that it can be used for writing. As described above, housing 110 supports and encases all the parts required for operation except for the lead 112 extended beyond the bottom opening of the housing 110 and the button 111 that is depressed and released by the user. Housing 110 holds lead case 104 and is supported with back bush 103 (not shown). An interface 111/104-2 is formed between the ledges 104-2 of lead case 104 and the forward edges of legs 111-3 of button 111. It will be seen that downward motion of those forward edges will urge the entire body of lead case 104 downward an against the spring 105 pressure. Springs 105 (which may be encased in supporting plastic or metal cylinders) urge the structure attached to lugs 104-4 and 106-2 away from each other. Lead 112 is shown in broken lines, as are ledges 104-2. Front guide 108 is snap fitted into the bottom end of lead case 104 so that it is drawn into cube ring 107, which is in turn secured in the bottom end of body bush 106.

FIG. 47 further shows that the sections 108-3 of front guide 108 have been drawn into the cube ring 107, causing the greatest level of compression on the long sides of lead 112 between them. Lead 112 extends from the bottom end of body bush 108 to the top end of front bush 109, thereafter extending through front bush 109 to the opening in housing 110 for lead 112. The compression of lead 112 between surfaces 108-10 by arms 108-2 being drawn into cube ring 104 prevents lead 112 from being pushed back into lead case 104 when the user is writing with the invention pencil.

FIG. 48 shows the invention mechanism in a side cutaway view with the side knock button 111 depressed, urging the lead 112 forward. FIG. 48 is substantially the view of FIG. 47 with the button 111 depressed and showing the resulting action. Arms 108-2 of front guide 108 are extruded beyond the bottom opening of cube ring 107, releasing substantial pressure on the lead 112 between surfaces 108-10 of sections 108-3. The moving downward of front guide 108 causes lead 112 to be advanced and the gripping compression to be substantially reduced. When button 112 is released, lead 112 stays in substantially the location to which it was moved as shown in FIG. 48.

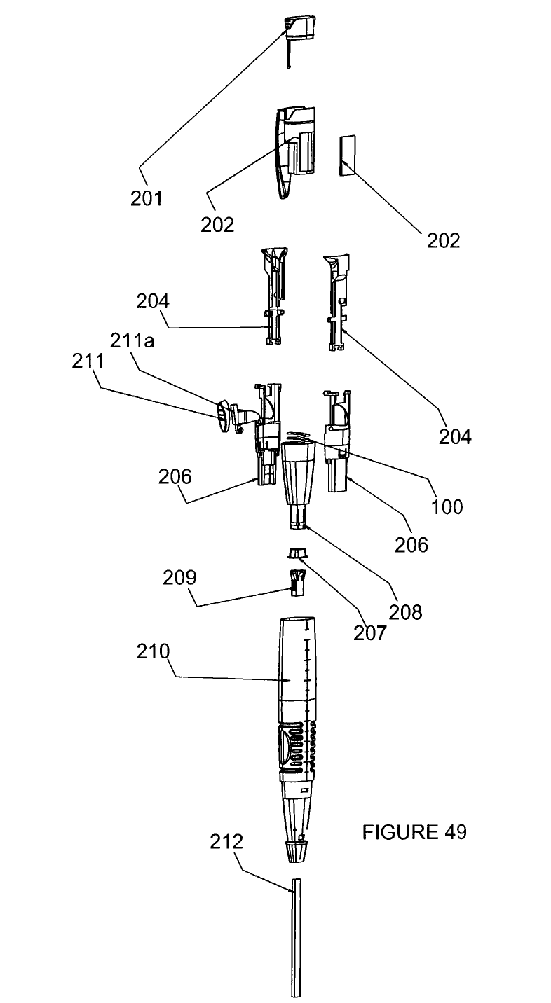

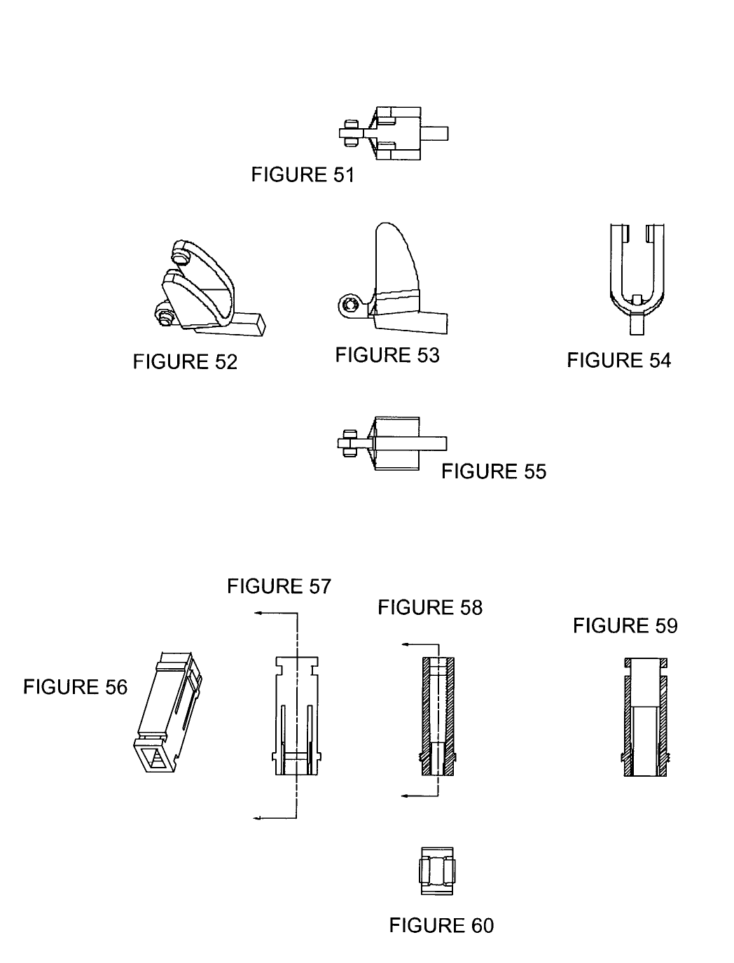

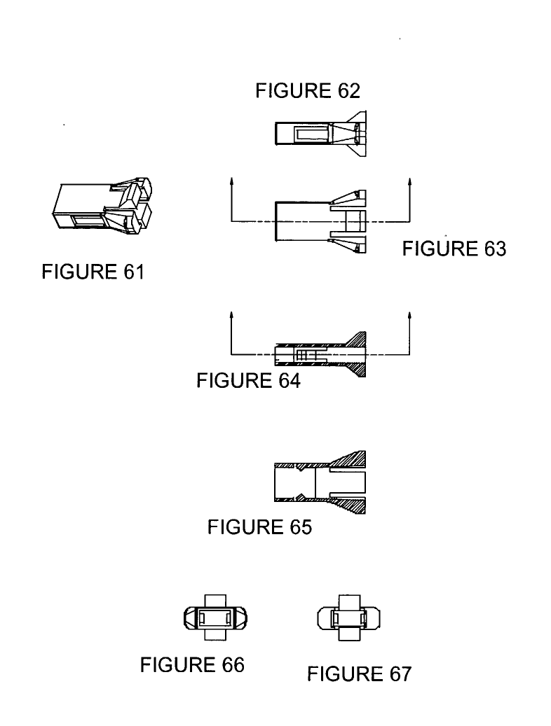

The invention embodiment of FIGS. 49-67 is similar in structure and operation to the embodiment of FIGS. 1-48, where the aspect item numbers are only increased by 100 between them (i.e., the front bush 108 of FIGS. 31-38 is substantially similar in structure and operation as the front bush 208 of FIGS. 61-67). The changes to the embodiment of FIGS. 49-67 comprise the description below.

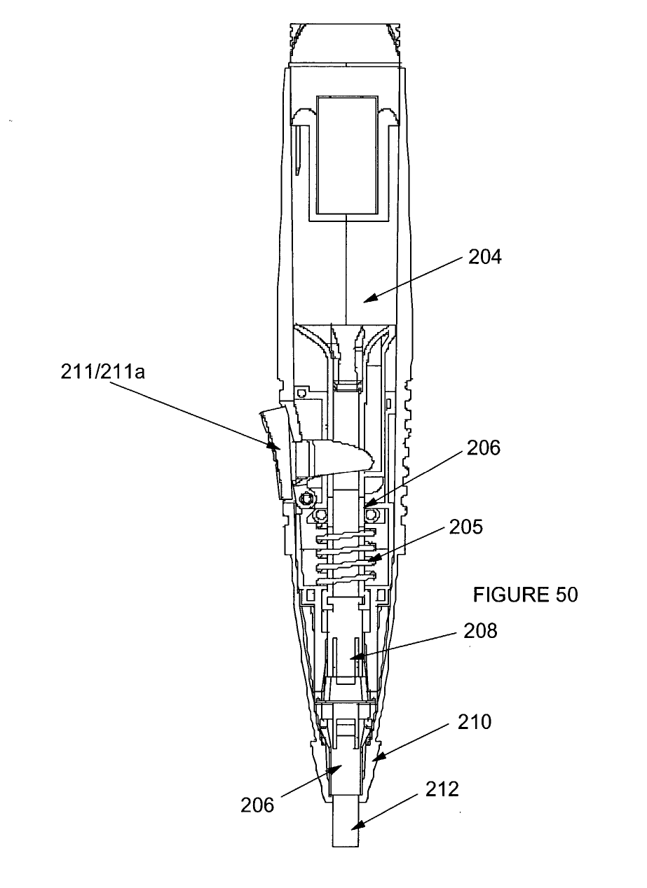

A lead case 204 with a narrowed front portion with a bore in about the front half that is about the cross sectional shape as that of a single lead 212 to be used in the pencil. This change more securely supports an engaged lead 212 (as in FIG. 50) within the case 204, thereby also providing guidance for insertion of the lead 212 from the back end of case 204. Another preferred dimension for a lead 212 to be used in the invention pencils is 70 mm(L)×2.5 mm(H)×5.0(W).

The changes made in the parts permit the invention pencil to be made substantially thinner at the housing 210 as compared with the housing 110 of the other embodiment.

Cap end pieces 201 and 202 are adapted to secure a magnet for support and storage of the invention pencil on a metal surface.

Button 211/211a comprises two parts instead of a single part 111. The contact piece 211 is connected to piece 211a via a bar portion located on a top side. Piece 211a is adapted so that inward facing and opposing lugs on legs 111-3 (as in FIGS. 27-30). The changes in this embodiment permit more secure force transference from the button 211/211a to the lead case 204 to thereby cause lead 212 to advance according to the mechanism and structure as described above for the invention pencil.

The above design options will sometimes present the skilled designer with considerable and wide ranges from which to choose appropriate apparatus and method modifications for the above examples. However, the objects of the present invention will still be obtained by that skilled designer applying such design options in an appropriate manner.

I claim:

1. A mechanical pencil for advancing and securing a rectangular or square lead comprising:
(a) a housing having a longitudinal body with a first axis for location and advancement of the lead and defining an internal cavity and an opening at a bottom end of the first axis adapted for extrusion of the lead at a bottom end;
(b) a front guide having a top part and a bottom part and defining a slotted passage for the lead along the first axis running from the top part to the bottom part, respectively with a top front guide opening at one end and a bottom front guide opening at the other end, where two arms are connected at the top part and extend to the bottom part to form slots whereby a cross section circumference at the top part increases to a maximum cross section part at the end of the bottom part forming a compression section;
(c) a body bush having means for securing the body bush in the housing thereby rigidly and along the first axis slidably securing the bottom part of the front guide at a bottom opening defined in a bottom part of the body bush such that locating the lead in the front guide passage and drawing the front guide upward along the first axis until the thickest part of compression section is located in the bottom opening of the body bush results in substantially more compression of the arms on the lead in the bottom part of the than when the front guide is moved downward so that the compression section is moved beyond the bottom end of the body bush; and
(d) means for securing the top part of the front guide so that its passage for the lead is maintained along the first axis and means for causing the front guide to move downward along the first axis when the lead is located in the front guide passage and is in a first location where the front guide is drawn upward along the first axis until the thickest part of compression section is located in the bottom opening of the body bush.

2. The pencil of claim 1 wherein a longitudinal lead case is located along the first axis and defines an internal cavity adapted for retaining the lead and a bottom opening at a bottom end along the first axis, where the bottom opening is adapted to allow passage of the lead without substantial resistance.

3. The pencil of claim 2 wherein the bottom opening of the lead case is adapted for insertion of a top part of a front guide at the lead case bottom opening, whereby the lead case bottom end.

4. The pencil of claim 2 wherein spring means urge apart the lead case and body bush parallel to the first axis, where the lead case is slidable along the first axis and is prevented from entirely releasing the force of the spring means.

5. The pencil of claim 4 wherein a user button is adapted to cause urging together along the first axis the bottom end of the lead case and a top part of the body bush, so that its action forces the front guide downward and moving the front guide compression section away from the bottom opening of the body bush.

6. The pencil of claim 1 wherein a front bush is adapted to receive lead advanced from the bottom part of the front guide and thereafter guide without substantial resistance to the housing opening for the lead at the bottom end of the first axis.

7. The pencil of claim 1 wherein the means for securing the top part of the front guide are operatively connected by spring means with the body bush.

8. The pencil of claim 7 wherein spring means urge apart the means for securing the top part of the front guide and a top part of the body bush so that compression of the spring means results in downward movement of the front guide relative to the housing while the body bush remains fixed.

9. The pencil of claim 8 wherein the opening at the bottom part of the body bush has located in it an insert adapted to reduce friction between an outside surface of the arms of the front guide and the inside surface of the opening at the bottom part of the body bush.

10. The pencil of claim 9 wherein the insert is a metal or plastic ring.

11. The pencil of claim 1 wherein the front guide comprises a natural or synthetic elastomer.

12. The pencil of claim 5 wherein the user button is accessible from a longitudinal side of the pencil housing.

13. The pencil of claim 5 wherein the user button is accessible from a top end of the pencil housing.
